(19) United States
(12) Patent Application Publication
(10) Pub. No.: US 2024/0227008 A9
(43) Pub. Date: Jul. 11, 2024

(54) PRODUCING METAL MATRIX COMPOSITE FEEDSTOCK FOR THREE-DIMENSIONAL PRINTING

(71) Applicant: Divergent Technologies, Inc., Los Angeles, CA (US)

(72) Inventor: Chan Cheong PUN, Costa Mesa, CA (US)

(21) Appl. No.: 18/488,883

(22) Filed: Oct. 17, 2023

Related U.S. Application Data
(60) Provisional application No. 63/417,912, filed on Oct. 20, 2022.

(51) Int. Cl. B22F 9/08; B22F 1/12; B33Y 70/10

(52) U.S. Cl. CPC B22F 9/082; B22F 1/12; B33Y 70/10; B22F 2301/052; B22F 2302/105

(57) ABSTRACT

Methods for producing aluminum metal matrix composite feedstocks are disclosed. A method in accordance with an aspect of the present disclosure may comprise heating a metal into a liquid, spraying the liquid through a nozzle to produce droplets, directing a stream of ceramic particles to contact the droplets to form a compound material, the compound material comprising the droplets and the ceramic particles, and obtaining a powder from the droplets.

### CROSS-REFERENCE TO RELATED APPLICATIONS

This application claims the benefit of, and right to priority to, U.S. Provisional Application No. 63/417,912 filed on Oct. 20, 2022, entitled “PRODUCING AI-MMC FEEDSTOCK FOR 3D PRINTING”, the entirety of which is incorporated by reference as if fully set forth herein.

### BACKGROUND

### Field

The present disclosure relates generally to producing metal matrix composite (MMC) material, and more specifically to producing MMC feedstock for three-dimensional (3-D) printing.

### Background

Three-dimensional (3-D) printing, also referred to as additive manufacturing (AM), presents new opportunities to more efficiently build structures, such as automobiles, aircraft, boats, motorcycles, busses, trains, and the like. Applying AM processes to industries that produce these products has proven to produce structurally efficient transport structures. For example, an automobile produced using 3-D printed components can be made stronger, lighter, and consequently, more fuel efficient. Moreover, AM enables manufacturers to 3-D print parts that are much more complex and that are equipped with more advanced features and capabilities than parts made via traditional casting, forging, and machining techniques.

Despite these recent advances, a number of obstacles remain with respect to the practical implementation of AM techniques. For example, many existing alloys can be cast or molded to produce structures relatively free of defects, but when 3-D printed these alloys exhibit cracking and/or other defects. When components of a specified strength and/or ductility are desired in certain applications, manufacturers may be relegated to manufacturing the component using traditional casting, forging, and machining techniques because 3-D printing the components using existing alloys would result in components that are too weak or brittle.

### SUMMARY

Several aspects and features of producing MMC feedstock for 3-D printing will be described more fully hereinafter. MMC feedstock may provide increased mechanical properties such as yield and ultimate tensile strength in the final 3-D printed structure. Depending on the volume percentage of ceramic materials added, mechanical property such as stiffness may be significantly increased up to 30% in aluminum alloys, for example. The aforementioned improvements pave the road for topological optimization where 3-D printed structure weight can be drastically reduced. In some cases, nano ceramic additions may increase printability of materials because the nano particles can act as grain nucleation sites for grains to grown from and reduces residual stresses that lead to cracking.

A method in accordance with an aspect of the present disclosure may comprise heating a metal into a liquid, spraying the liquid through a nozzle to produce droplets, directing a stream of ceramic particles to contact the droplets to form a compound material, the compound material comprising the droplets and the ceramic particles, and obtaining a powder from the droplets.

Such a method may further optionally include directing a gas stream at the droplets to modify a surface tension of the droplets, spheroidizing the compound material into a powder, the metal being aluminum, the ceramic particles being at least silicon carbide, boron carbide, or titanium diboride, the powder being an additive manufacturing feedstock, the droplets being directed by a gas stream that comprises at least air, argon, or nitrogen, and directing the stream of ceramic particles comprising directing the stream of ceramic particles via the gas stream.

A method in accordance with an aspect of the present disclosure may comprise directing a stream of ceramic particles at a sheet of a metal to fix the ceramic particles to the sheet, and atomizing the sheet into particles of a powder, wherein the particles include the ceramic particles and the metal.

Such a method may further optionally include rolling the sheet into a cylindrical object, spheroidizing the particles of the powder, maintaining a temperature of the sheet at or below a solidus temperature of the metal, the sheet being at least 0.10 mm thick, rolling the sheet comprising placing the sheet into a roller mill, atomizing the metal sheet comprises at least plasma atomization, ultrasonic atomization, wire arc atomization, or gas atomization, directing the stream of ceramic particles further comprising introducing the ceramic particles into a gas stream, the gas stream being at a pressure between 100 psi and 1000 psi, the gas stream comprising at least air, argon, or nitrogen, the powder being an additive manufacturing feedstock, and the ceramic particles are between one nanometer and 10 microns in size.

A method in accordance with an aspect of the present disclosure may comprise combining a plurality of ductile particles and a plurality of brittle particles, cold welding the plurality of ductile particles and the plurality of brittle particles into a compound material by milling the plurality of ductile particles with the plurality of brittle particles, and obtaining a plurality of alloyed particles from the compound material.

Such a method may further optionally include hardening the compound material, spheroidizing the plurality of alloyed particles, the plurality of ductile particles being aluminum particles, the plurality of brittle particles being at least silicon carbide, boron carbide, or titanium diboride, the plurality of alloyed particles being an additive manufacturing feedstock, and the milling comprises ball milling.

It will be understood that other aspects of printable alloys will become readily apparent to those skilled in the art from the following detailed description, wherein it is shown and described only several embodiments by way of illustration. As will be appreciated by those skilled in the art, the principles of the disclosure can be realized with other embodiments without departing from the invention. Accordingly, the drawings and detailed description are to be regarded as illustrative in nature and not as restrictive.

### BRIEF DESCRIPTION OF THE DRAWINGS

Various aspects of the present disclosure will now be presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIGS. 2A-2C illustrate alloy structures in accordance with an aspect of the present disclosure.

FIG. 3 illustrates a unit cell of a structure in accordance with an aspect of the present disclosure.

FIG. 4 illustrates a device and method in accordance with an aspect of the present disclosure.

FIG. 5 illustrates a device and method in accordance with an aspect of the present disclosure.

FIG. 6 illustrates atomizing a cylinder in accordance with an aspect of the present disclosure.

FIG. 7 illustrates a device and method in accordance with an aspect of the present disclosure.

FIG. 8 illustrates a flow diagram illustrating an exemplary method for producing a feedstock in accordance with an aspect of the present disclosure.

FIG. 9 illustrates a flow diagram illustrating an exemplary method for producing a feedstock in accordance with an aspect of the present disclosure.

FIG. 10 illustrates a flow diagram illustrating an exemplary method for producing a feedstock in accordance with an aspect of the present disclosure.

### DETAILED DESCRIPTION

The detailed description set forth below in connection with the drawings is intended to provide a description of exemplary embodiments of producing MMC feedstock for three-dimensional (3-D) printing, and it is not intended to represent the only embodiments in which the invention may be practiced. The term “exemplary” used throughout this disclosure means “serving as an example, instance, or illustration,” and should not necessarily be construed as preferred or advantageous. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

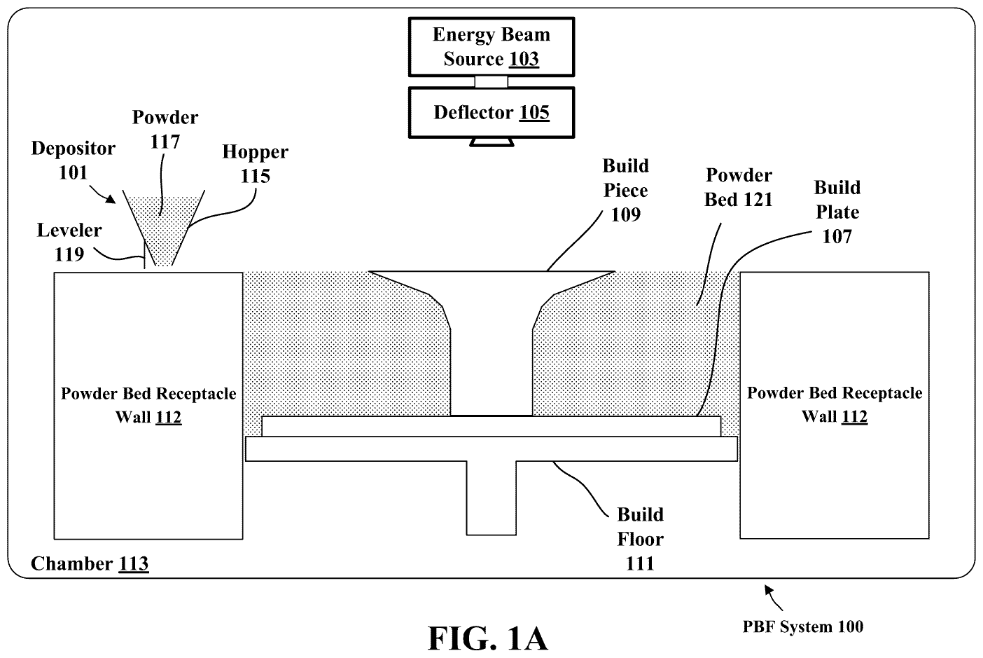

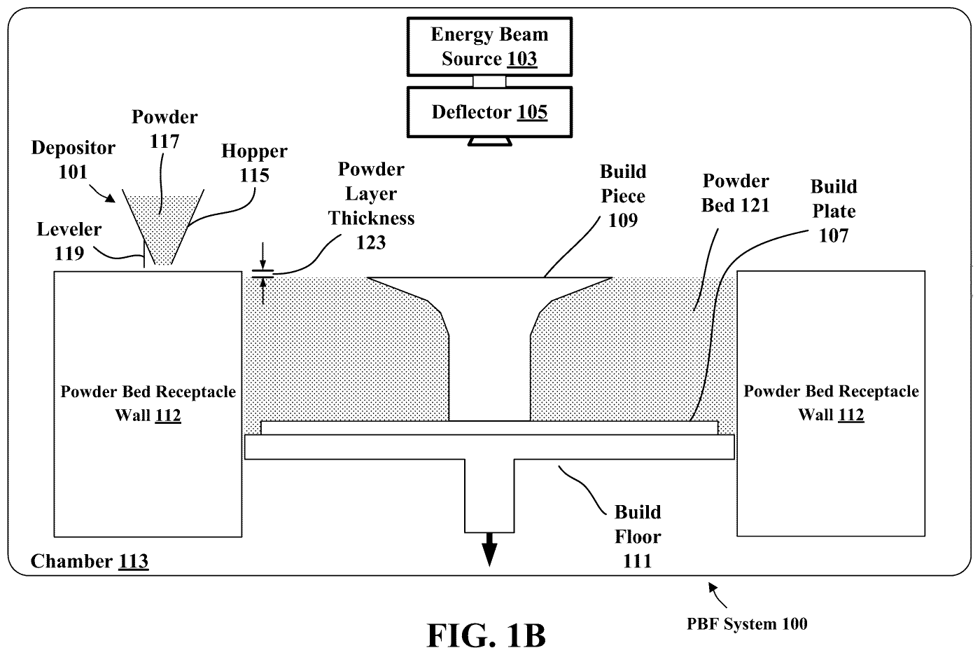

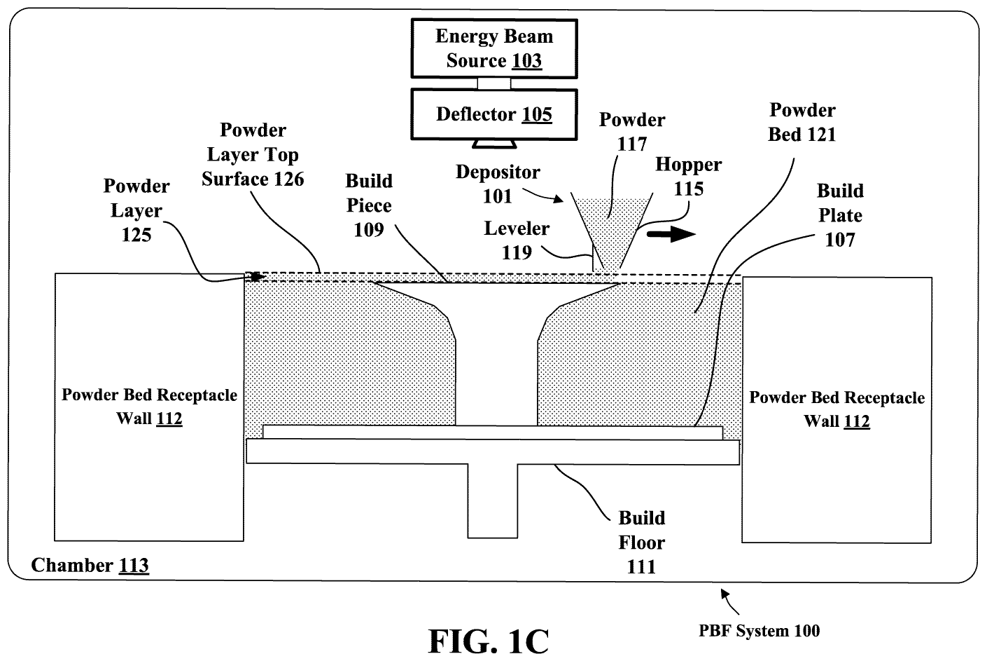

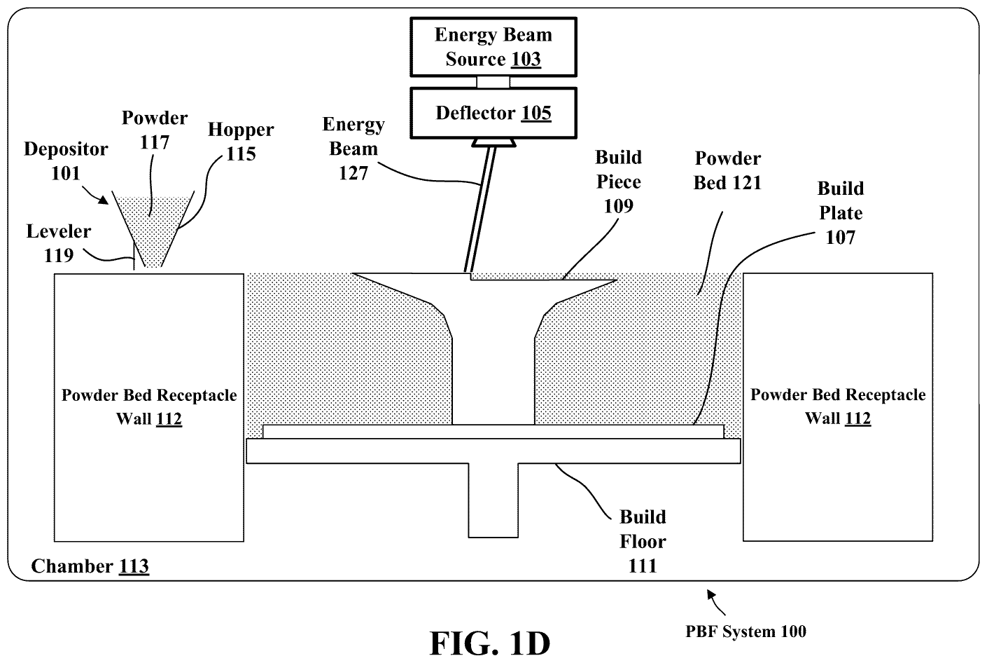

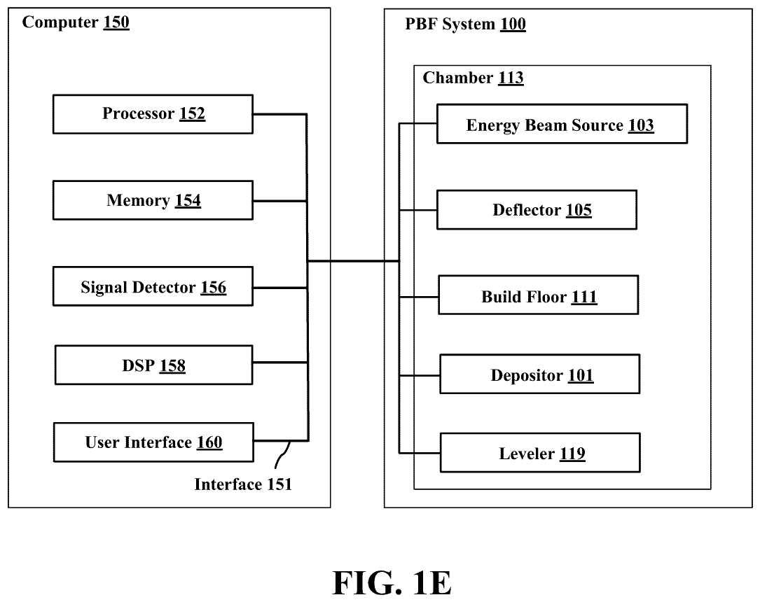

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder (which is a type of feedstock for some 3-D printers, such a PBF printers), an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 175 layers, to form the current state of build piece 109, e.g., formed of 175 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 with a powder layer top surface 126 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 174 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

The processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117 remaining in depositor 101, leveler 119 position, and other signals. DSP 158 may be used in processing signals received by the computer 150. The DSP 158 may be configured to generate instructions and/or packets of instructions for transmission to PBF system 100.

The user interface 160 may comprise a keypad, a pointing device, and/or a display. The user interface 160 may include any element or component that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described above with respect to the processor 152, but also to implement the functionality described above with respect to the signal detector 156, the DSP 158, and/or the user interface 160. Further, each of the components illustrated in FIG. 1E may be implemented using a plurality of separate elements.

### Alloy Compositions

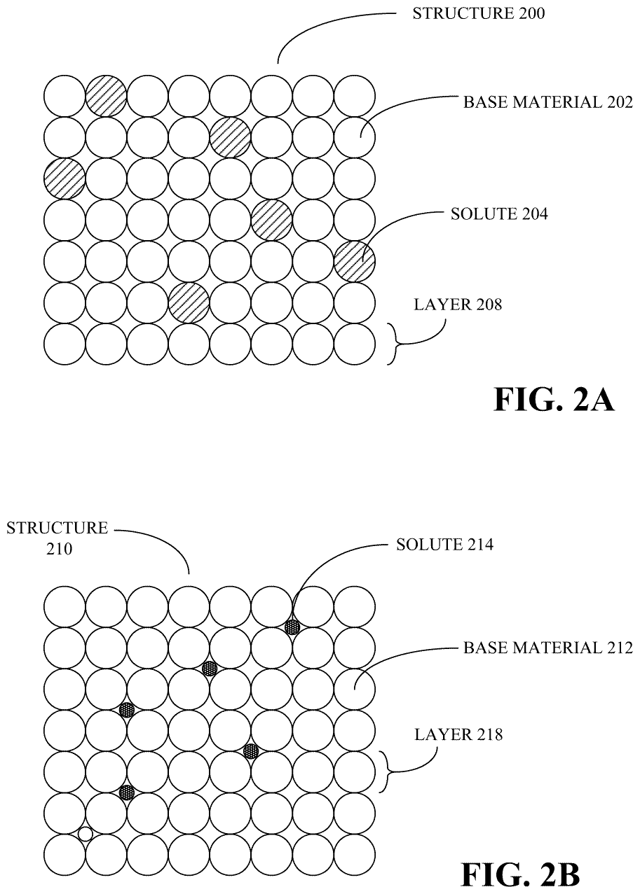

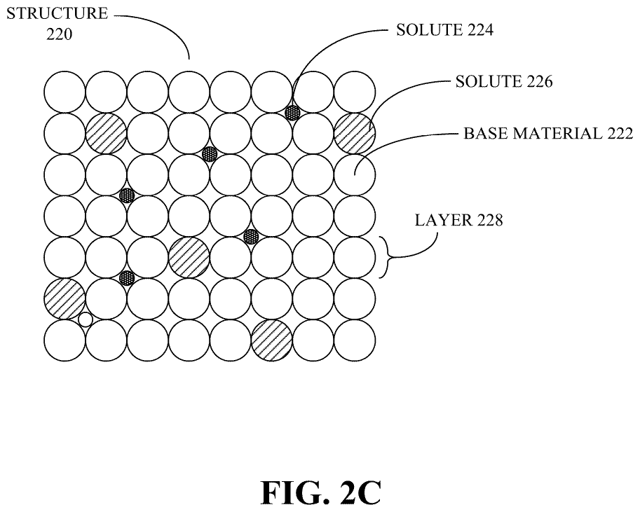

FIGS. 2A and 2B illustrate alloy structures in accordance with an aspect of the present disclosure.

FIG. 2A illustrates an alloy structure 200 with base material atoms and solute 204 atoms included in alloy structure 200. In an aspect of the present disclosure, alloy structure 200 may have an underlying structure of the base material, which may be, for example, a crystalline-type or periodic structure, such as a cubic structure, i.e., where an atom of the base material is located at each corner of a cube, a face-centered cubic structure, i.e., where an atom of the base material is located at the corners and in at least one face of a cube, etc. For example, as a base material, aluminum (Al) metal arranges in a face-centered cubic (fcc) structure, titanium arranges in a body-centered cubic (bcc) structure or a hexagonal close packed (hcp) structure, etc. As shown in FIG. 2A, atoms of base material 202 can be arranged in layers, such as a base material layer 208, which may include one or more atoms of substitutional solute 204.

In FIG. 2A, the base material structure of alloy structure 200 is shown as a cubic structure, however, the principles described with respect to alloy structure 200 may be applied to any base material structural arrangement without departing from the scope of the present disclosure. In FIG. 2A, at some locations within alloy structure 200, base material 202 has been replaced by solute 204. With a replacement approach, an alloy may be referred to as a “substitutional alloy,” because the solute 204 is substituting for the base material 202 within the base material structure of alloy structure 200. In an aspect of the present disclosure, solute 204 may be one or more different atoms and/or compounds that act as substitutional replacements for base material 202. For example, and not by way of limitation, base material 202 may be iron (Fe), and solute 204 may be one or more of nickel (Ni), chromium (Cr), and/or tin (Sn). Substitutional alloys may be formed when the solute 204 is of approximately the same atomic size as base material 202.

In FIG. 2B, an alloy structure 210 includes a base material 212 within a cubic structure like the base material structure shown in FIG. 2A. Like FIG. 2A, the principles described with respect to alloy structure 210 may be applied to any base material structural arrangement without departing from the scope of the present disclosure. Alloy structure 210 also includes a solute 214. Solute 214 is included in alloy structure 210 at locations other than the locations of base material 212, i.e., at interstitial locations within base material structure of alloy structure 210. In such an aspect of the present disclosure, an alloy with such an addition to base material 212 may be referred to as a “interstitial alloy,” because the solute 214 is being made part of the structure at interstitial locations within the base material structure of alloy structure 210. In such an aspect, solute 214 may be one or more different atoms and/or compounds that act as interstitial insertions into the base material structure of alloy structure 210. For example, and not by way of limitation, base material 212 may be aluminum (Al), and solute 214 may be one or more of magnesium (Mg), zirconium (Zr), and/or manganese (Mn). Interstitial alloys may be formed when solute 214 is of a smaller atomic size than base material 212. As shown in FIG. 2B, atoms of base material 212 can be arranged in layers, such as a base material layer 218, which may include one or more atoms of interstitial solute 214 interspersed between the layers.

FIG. 2C illustrates an example of a combination alloy, with an alloy structure 220 that can include a base material 222, an interstitial solute 224, and a substitutional solute 226. As shown in FIG. 2C, atoms of base material 222 can be arranged in layers, such as a base material layer 228, which may include one or more atoms of substitutional solute 226 and interspersed with one or more atoms of interstitial solute 224.

Aspects of the present disclosure can include substitutional alloys, interstitial alloys, and combination alloys with combinations of substitutional/interstitial solutes in a given alloy. Further, a base material (such as base material 202, 212, and 222) may include one or more elements, e.g., the base material may be a plurality of two materials, e.g., copper (Cu) and zinc (Zn), without departing from the scope of the present disclosure. Although the use of “base” in base material may mean that the base material is the majority of the composition of the alloy, such meaning is not necessarily always the case in many aspects of the present disclosure. In various embodiments, base material may indicate an underlying structure of the alloy, since different materials have different atomic arrangements, e.g., fcc, bcc, cubic, hcp, etc.

In an aspect of the present disclosure, solutes can be included with a base material to change one or more properties that the base material exhibits. For example, and not by way of limitation, carbon (C) may be added to Fe to increase strength and reduce oxidation. In other words, solutes may be added as impurities to a base material to change the characteristics of the bonds between atoms within a base material structure.

In many materials, and in many alloys, there are several basic characteristics that determine the suitability of that material/alloy for a given application. For example, and not by way of limitation, strength, heat resistance, and ductility are three characteristics that may be of interest in certain applications.

As shown in FIGS. 2A-C, a structure of an alloy, which may include base material(s) and solutes, can be classified in terms of its underlying atomic arrangements (e.g., fcc, bcc, hcp, etc.). Alloy structures can be made in a number of ways, but they are primarily fashioned by mixing together a base material with solutes (e.g., substitutional and/or interstitial) in various ratios and/or percentages. This may be done through smelting and/or melting the various components into a homogenous liquid and allowing the liquid to cool into a solid form.

The resultant alloy structure, whether interstitial, substitutional, polycrystalline, amorphous, or various combinations, provides different values for the properties of the alloy than the properties of the base material in a pure form. For example, alloying gold (Au) with silver (Ag) makes the resultant alloy harder, i.e., the resultant alloy of Au and Ag has a higher tensile strength than pure Au. Another reason that a pure base material structure may show reduced strength is that covalent and/or ionic bonding between atoms of the same element is limited. Since alloys contain a mixture of atom sizes, and a variety of valence electrons because some of the atoms in the alloy's structure can have slightly different sizes and/or different localized electrical properties, it is more difficult for layers in the base material arrangement, such as base material layers 208, 218, and 228, to shift with respect to one another, as the arrangement of atoms is no longer uniform and the localized bond strength between neighboring atoms may be increased. This increase in strength of the alloy may be due to the slight difference in size of a substitutional solute, the inclusion of an interstitial solute, and/or other reasons.

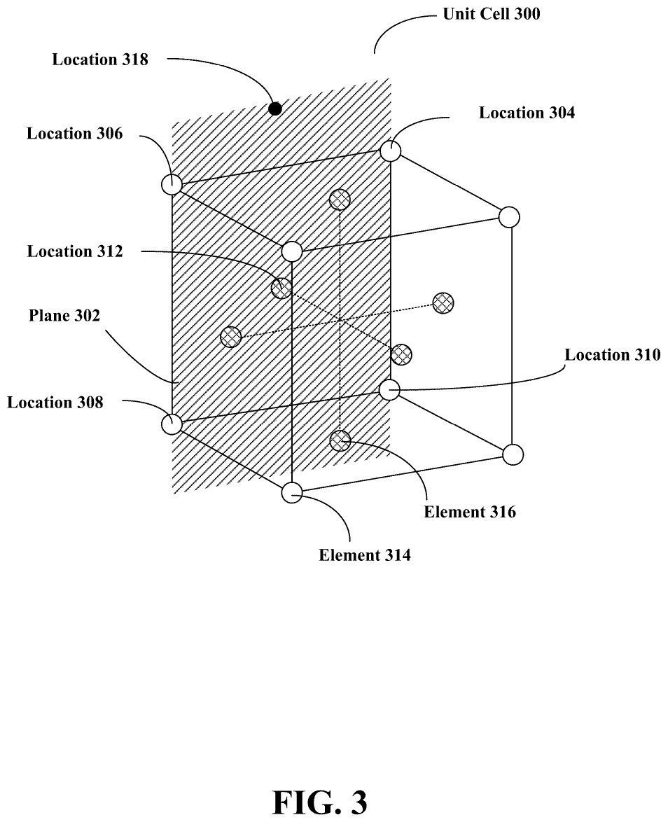

FIG. 3 illustrates a unit cell of a structure in accordance with an aspect of the present disclosure.

Unit cell 300 shows a single cube of an alloy structure, which, as illustrated in FIG. 3, is a face centered cubic (fcc) structure. For ease of understanding plane 302 is shown, although unit cell 300 has six planes that are approximately perpendicular to each other at each intersection. Other unit cells 300 are possible, e.g., bcc, cubic, hcp, etc., without departing from the scope of the present disclosure.

Plane 302 is described by five atomic locations: location 304, location 306, location 308, and location 310, which define the “corners” of plane 302, and location 312, which defines the “center” of plane 302 within the face of the unit cell closest to the viewer. In an alloy structure, one unit cell 300 may be adjacent to another unit cell 300, etc., such that a large array of unit cells 300 defines the alloy structure.

An element 314 is located in this example at each of the corners of unit cell 300, including at locations 304, 306, 308, and 310 of plane 302. An element 316 is located at the center of each one of the six planes, including at location 312. That is, as shown in FIG. 3, locations 304-310 are occupied by element 314, and location 312 is occupied by element 316. Element 314 may be the same material/element as element 316, or may be a different material/element depending on the composition of the resultant alloy. In an alloy structure with unit cells 300 of a pure material, e.g., aluminum, each location 304-310 and location 312 would be occupied by aluminum. If a substitutional solute were introduced as an alloying material for pure aluminum, then one or more locations 304-312 may be occupied by the alloying material, e.g., vanadium, chromium, etc. If an interstitial solute were added as an alloying material for pure aluminum, such a solute may be located, for example, location 318. Location 318 is between location 306 and location 304, and in an aspect of the present disclosure, within plane 302. Other locations for an interstitial solute are possible without departing from the scope of the present disclosure.

Aluminum, which has an fcc unit cell as shown in FIG. 3, has been alloyed with various solutes. Some aluminum alloys have been standardized and named based on which solute(s) are included in the named alloy. For example, and not by way of limitation, the International Alloy Designation System (LADS) is a widely-accepted naming scheme for aluminum alloys, where each alloy is referred to using a four-digit number. The first digit of the number indicates the major solute elements included in the alloy. The second digit indicates any variants for that solute alloy, and the third and fourth digits identify a specific alloy in that series.

For aluminum alloys named (i.e., numbered) in the LADS, 1000 series alloys are essentially pure aluminum content by wt %, and the other digits represent various applications for such alloys. 2000 series aluminum alloys are alloyed with Cu, 3000 series aluminum alloys are alloyed with Mn, 4000 series aluminum alloys are alloyed with silicon (Si), 5000 series aluminum alloys are alloyed with Mg, 6000 series aluminum alloys are alloyed with Mg and Si, 7000 series aluminum alloys are alloyed with Zn, and 8000 series aluminum alloys are alloyed with other elements or a combination of elements that are not covered by other series designations. As an example, and not by way of limitation, a common aluminum alloy is referred to as “6061” which, per the IADS naming scheme, has Mg and Si as the major alloying solutes. However, 6061 has other alloying solutes, in various percentages, e.g., iron (Fe), copper (Cu), chromium (Cr), zinc (Zn), titanium (Ti), and manganese (Mn), and is allowed to have other solutes, which may be referred to as “impurities,” of less than a certain percentage. The solutes present in 6061 may have a range of wt % depending on the application, manufacturer, alloying tolerances, and/or other reasons.

However, when the manufacturing process of creating such alloys is changed from smelting, forging, and/or casting to 3-D printing, the formation of the alloy structure and/or unit cells 300 within the alloy structure becomes localized. Since 3-D printing only applies thermal energy to a small portion of the overall alloy structure at any given time, the formation of unit cells 300 happens on a local scale in a build piece 109 instead of on a global scale, for example, in a cast piece. As a result of the local versus global thermal energy application, and local versus global cooling of the build piece 109, it has been seen that some named, common alloys of aluminum are difficult to 3-D print without introducing micro-fractures and/or other deleterious structural defects in the build piece 109.

In an aspect of the present disclosure, any one or more of the alloys described above may be used in the methods herein to produce MMC feedstock, which may be, for example, placed into hopper 115, and the build process described in FIGS. 1A-1E of the present disclosure may be undertaken for that MMC feedstock.

### Producing MMC Feedstock

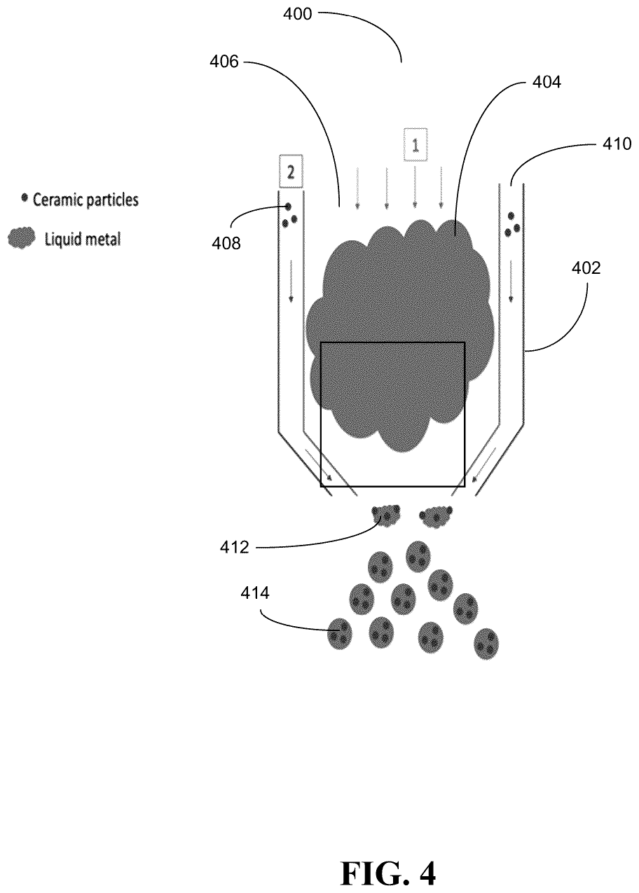

FIG. 4 illustrates a device and method in accordance with an aspect of the present disclosure.

Device 400 comprises one or more nozzles 402 (only one shown for clarity) having a metal 404 (e.g., aluminum or other metal) in an inner portion 406 of nozzle 402. Metal 404 may be melted into a liquid form by induction melting, arc melting, or other methods to liquidize the metal 404. The one or more nozzles 402 may be part of a larger component, e.g., a shower head, a linear rod with multiple nozzles, etc. without departing from the scope of the present disclosure.

Particles 408 may be introduced into an outer portion 410 of nozzle 402. Particles 408 may be ceramic particles, although other materials can be used without departing from the scope of the present disclosure. Particles 408 may be of various sizes, or may be of relatively uniform size. For example, particles 408 may be ceramic particles, sized between several nanometers and several microns, or may be a relatively uniform sized ceramic particle of one to two microns.

The particles 408 and metal 404, once melted, may be forced via pressure, e.g., air, argon, nitrogen, gravity, centrifuge, pressure differential forces, etc. through the inner portion 406 and the outer portion 410 of the nozzle 402. As shown in FIG. 4, the nozzle 402 directs the particles 408 and metal 404 together, such that a composite grain 412 is created, containing one or more particles 408 and an amount of metal 404. For example, at or near the nozzle 402 exit, the particles 408 and liquid metal 404 collide, and particles 408 infiltrate the liquid metal. Composite grain 412 can be an MMC formed of metal 404 and particles 408 (e.g., ceramic particles).

In various embodiments, as the composite grain 412 cools to a solid form, the composite grain can cool to a spheroid grain 414. The spheroid grain 414, being in a solidified state, can then be used as a powder feedstock for additive manufacturing systems such as PBF system 100 described herein. In various embodiments, composite grain 412 may cool into non-spheroidal, e.g., irregular, shapes that may be used as feedstock.

When metal 402 is in liquid form and propelled through nozzle 402 by a gas stream, the effects of the gas stream, as well as the gas stream used to propel particles 408, may affect the surface tension of the metal 402 while it is still liquid, i.e., during the formation of composite grain 412. The method shown in FIG. 4 may be referred to as an “in-situ” method herein.

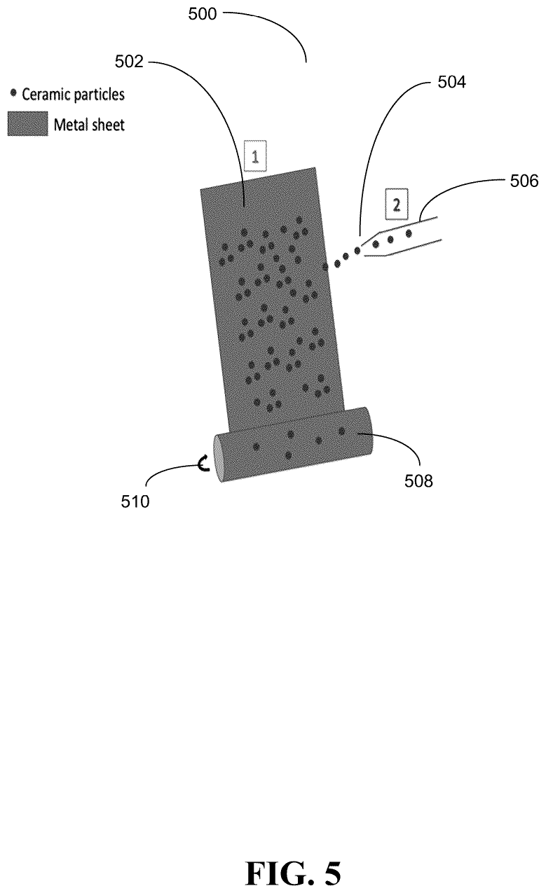

FIG. 5 illustrates a device and method in accordance with an aspect of the present disclosure.

Apparatus 500 shows a sheet 502 with particles 504 being bonded onto a surface of the sheet 502 from a nozzle 506. Sheet 502 may be an aluminum sheet, but may be other metals or materials without departing from the scope of the present disclosure. Particles 504 may be ceramic particles, although other materials can be used without departing from the scope of the present disclosure. Particles 504 may be of various sizes, or may be of relatively uniform size. For example, particles 504 may be ceramic particles, sized between several nanometers and several microns, or may be a relatively uniform sized ceramic particle of one to two microns.

Nozzle 506 directs particles 504 toward the surface of the sheet 502 such that the particles 504 are bonded, fixed, or otherwise coated onto or coupled to the sheet 502. Nozzle 506 may direct particles 504 at various pressures, e.g., between 300 to 1000 psi, but may be at higher or lower pressures as desired. Sheet 502 may be of any thickness, but is often 0.10 millimeters or thicker.

After the particles 504 are fixed on sheet 502, sheet 502 is then rolled into a cylindrical form 508 by winding or rotating the sheet 502 as shown by 510. Cylindrical form 508 may then be pressed into a more compact form if desired. 510 may also indicate a roller mill process as desired. The temperature of the sheet 502 and/or the cylindrical form 508 may be controlled such that the temperature does not exceed the solidus temperature of the material used for sheet 502. In various embodiments, cylindrical form (e.g., rod) 508 may be used as wire/rod feedstock for an atomization process, such as plasma atomization, ultrasonic atomization, wire arc atomization, gas atomization, etc., to produce powder MMC feedstock for powder-based 3-D printing processes. In various embodiments, cylindrical form 508 may be used as MMC wire/rod feedstock directly for wire/rod-based 3-D printing processes, such as wire-based direct energy deposition (DED), etc.

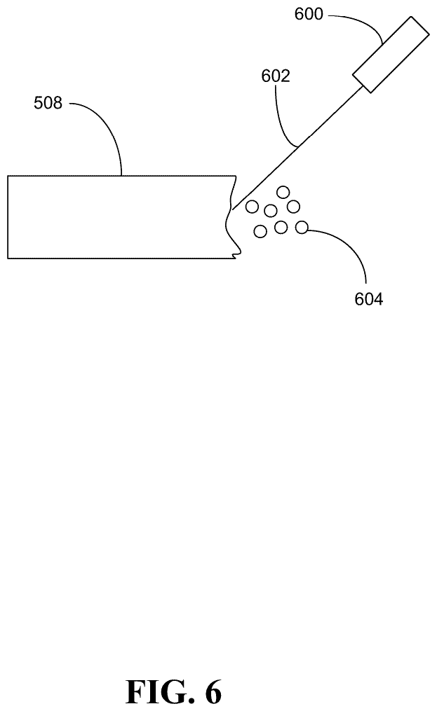

FIG. 6 illustrates atomizing a cylinder in accordance with an aspect of the present disclosure.

After formation of cylindrical form 508, an atomization source 600 may be directed toward cylindrical form 508 (also referred to as a cylinder 508 herein), shown as energy 602, to atomize cylindrical form 508 into particles 604. Atomization source 600 may be a plasma source, ultrasonic source, wire arc source, or other atomization source as desired. Consequently, energy 602 may be plasma, ultrasound, arcing, or other energy that may be used to atomize or otherwise fragment cylindrical form 508 into particles 604.

In an aspect of the present disclosure, particles (such as 408, 504, and 706 below) may be ceramic particles. Some examples of ceramic materials that may be used as particles are zirconium hydride (ZrH₂), titanium diboride (TiB₂), a mixture of zirconium hydride, hydride-dehydride titanium ((HDH) Ti) and boron carbide (B₄C), and other ceramic particles.

Some ceramic particles, such as ZrH₂, can have benefits in 3-D printing, such as enlarging the processing window of some processes, e.g., allowing for more deviation from ideal processing conditions and therefore making processing easier. However, ZrH₂ may also have adverse effects in additive manufacturing processes. For example, and not by way of limitation, adding zirconium hydride (ZrH₂) powder to a metal powder feedstock may affect the mechanical properties of an additively manufactured part, because the hydrogen porosity of the final part may increase. However, adding ZrH₂ directly into sheet 502 as shown in FIG. 5 and processed as shown in FIG. 6 may de-bond the hydrogen from the zirconium during the atomization process and produce low-hydrogen particles 604. Further, the hydrogen debonded during atomization may act as an oxygen displacement mechanism during the atomization/passivation shown in FIG. 6 and would be released and treated along with waste gas in the atomization process. The method shown in FIGS. 5 and 6 may be referred to as an “MMC-infused rolling” method herein.

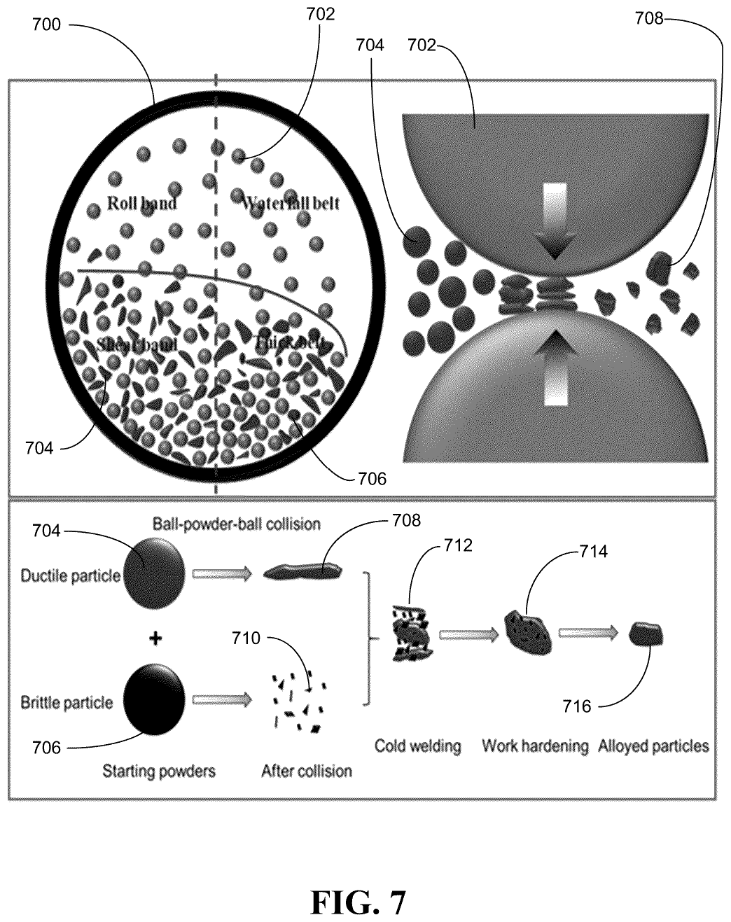

FIG. 7 illustrates a device and method in accordance with an aspect of the present disclosure.

In an aspect of the present disclosure, container 700 encloses a plurality of balls 702, a plurality of particles 704, and a plurality of particles 706. Particles 704 are ductile particles, and particles 706 are brittle particles. Particles 704 may be metal particles, such as aluminum or other metals. Particles 706 may be ceramic particles such as silicon carbide, boron carbide, or titanium diboride, or other ceramic particles. In an aspect of the present disclosure, container 700 and balls 702 may be a ball mill.

As the mill is operated, balls 702 can collide with particles 704 and particles 706, and particles 704 and particles 706 may change shape and/or size. For example, and not by way of limitation, particles 704 may be flattened, elongated, or otherwise changed in shape into particles 708. Similarly, particle 706 may be sheared, broken, or otherwise reduced in size to particles 710 during collisions with balls 702.

Further collisions between balls 702, particles 708, and particles 710 may produce particles 712, which are a combination of particles 708 and particles 710. This process of producing particles 712 may be considered a cold welding of particles 708 and particles 710.

Further milling or processing of particles 714 will harden, condense, or otherwise compact particles 712 into MMC particles 714. The processing of particles 714 into particles 716 may be considered work hardening of particles 712 to produce alloyed particles 714. Other hardening processes of particles 712 may be used without departing from the scope of the present disclosure.

Additional optional processing of MMC particles 714 may produce MMC particles 716. Such additional processing may include spheroidizing MMC particles 714 to produce particles 716, heat treating MMC particles 714 to heat-treated MMC produce particles 716, or other processing. MMC particles 714 and/or heat-treated MMC particles 716 may be used as powder feedstock for additive manufacturing processes. The method shown in FIG. 7 may be referred to as a “ball-mill A1-MMC” method herein.

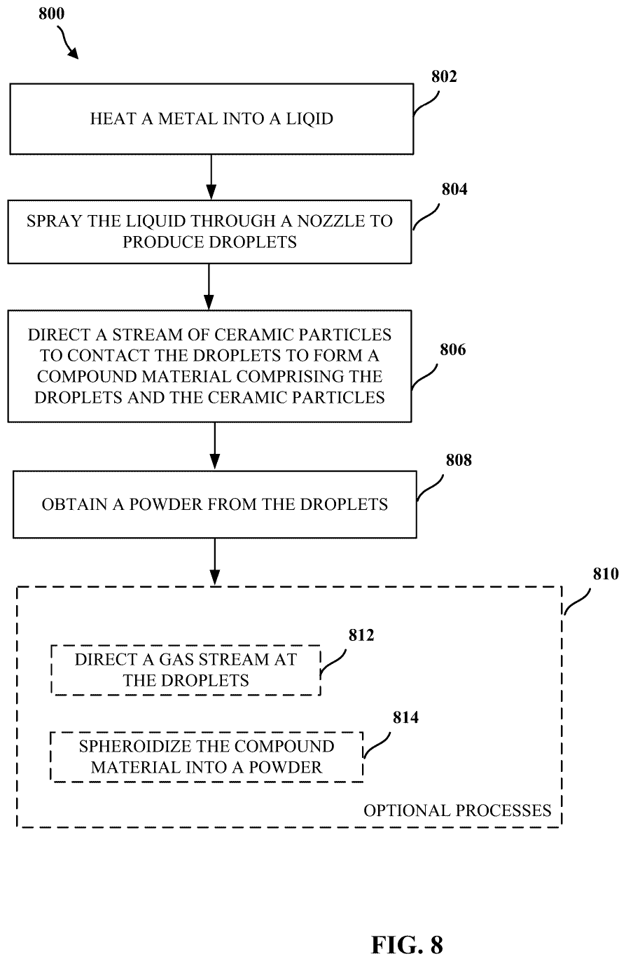

FIG. 8 illustrates a flow diagram illustrating an exemplary method for producing a feedstock in accordance with an aspect of the present disclosure.

Method 800 may describe example processes used during the “in-situ” method described with respect to FIG. 4 herein.

At 802, a metal is heated into a liquid. At 804, the liquid is sprayed through a nozzle to produce droplets. 804 may be performed by nozzle 402 as shown in FIG. 4.

At 806, a stream of ceramic particles is directed to contact the droplets to form a compound material, the compound material comprising the droplets and the ceramic particles. 806 may be performed by nozzle 402 and outer portion 406 as shown in FIG. 4.

At 808, a powder is obtained from the droplets. 808 may be performed by nozzle 402 and the powder may be described as composite grain 412 as shown in FIG. 4.

At 810, one or more optional processes may be undertaken. For example, 810 may include 812, where a gas stream is directed at the droplets to modify the surface tension of the droplets.

810 may also include 814, where obtaining the powder comprises spheroidizing the compound material into a powder, to obtain, e.g., spheroid grains 414.

810 may also include other features, such as the metal being aluminum, the ceramic particles being at least silicon carbide, boron carbide, or titanium diboride, the powder being an additive manufacturing feedstock, the gas stream comprising at least air, argon, or nitrogen, and where directing the stream of ceramic particles comprises directing the stream of ceramic particles via the gas stream.

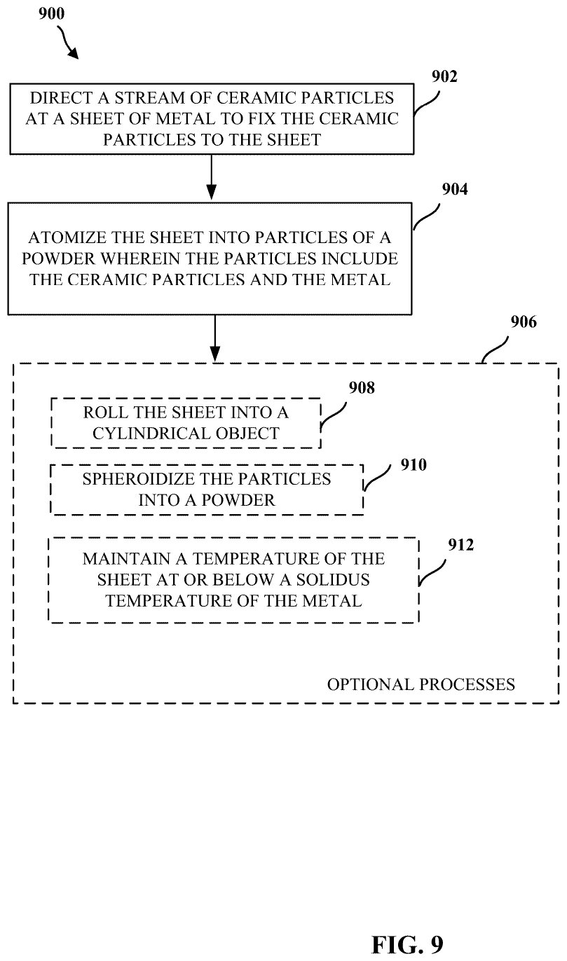

FIG. 9 illustrates a flow diagram illustrating an exemplary method for producing a feedstock in accordance with an aspect of the present disclosure.

Method 900 may describe example processes used during the MMC-infused rolling method described with respect to FIGS. 5 and 6 herein.

At 902 a stream of ceramic particles is directed at a sheet of a metal to fix the ceramic particles to the sheet. 902 may be performed by nozzle 506 as shown in FIG. 5.

At 904, the sheet is atomized into particles of a powder, wherein the particles include the ceramic particles and the metal. 904 may be performed by atomization source 600, as shown in FIG. 6.

At 906, one or more optional processes may be undertaken. For example, 906 may include 908, where the sheet is rolled into a cylindrical object. 906 may also include 910, where the particles are spheroidized into a powder. 906 may also include 912, where a temperature of the sheet is maintained at or below a solidus temperature of the metal.

906 may also include other optional processes, such as the sheet being at least 0.10 mm thick, rolling the sheet comprising placing the sheet into a roller mill, atomizing the metal sheet comprising at least plasma atomization, ultrasonic atomization, wire arc atomization, or gas atomization, directing the stream of ceramic particles further comprising introducing the ceramic particles into a gas stream, the gas stream being at a pressure between 100 psi and 1000 psi, the gas stream comprising at least air, argon, or nitrogen, the powder being an additive manufacturing feedstock, and the ceramic particles being between one nanometer and 10 microns in size.

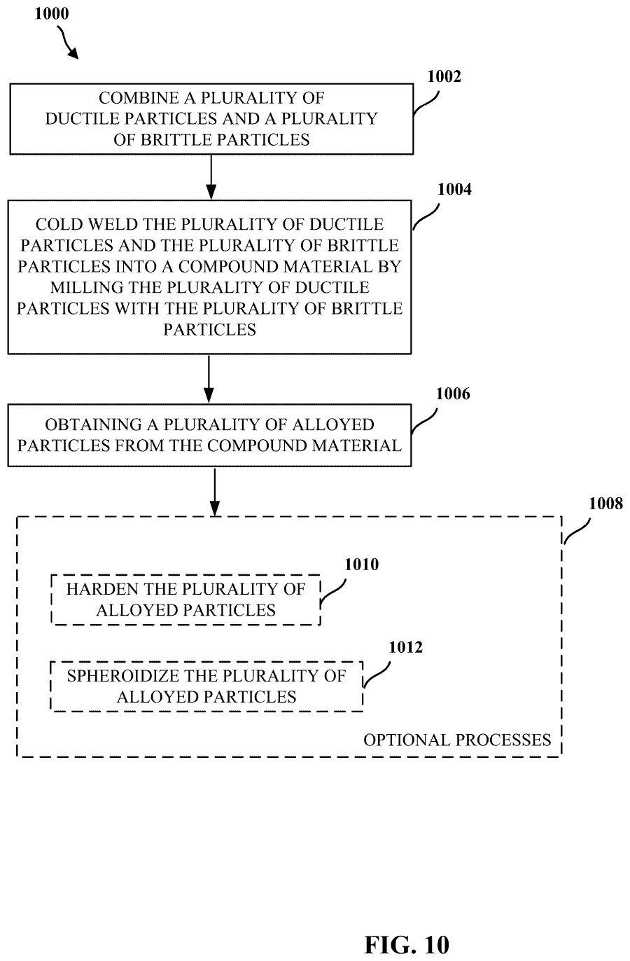

FIG. 10 illustrates a flow diagram illustrating an exemplary method for producing a feedstock in accordance with an aspect of the present disclosure.

Method 1000 may describe example processes used during the ball-mill A1-MMC method described with respect to FIG. 7 herein.

At 1002. A plurality of ductile particles and a plurality of brittle particles are combined. 1002 may be performed in container 700, which may be a ball mill as shown in FIG. 7.

At 1004, the plurality of ductile particles and the plurality of brittle particles are cold welded into a compound material by milling the plurality of ductile particles with the plurality of brittle particles. 1004 may be performed by container 700 and balls 702, which may be a ball mill as shown in FIG. 7.

At 1006, a plurality of alloyed particles are obtained from the compound material. 1006 may be performed by container 700 and balls 702, which may be a ball mill as shown in FIG. 7.

At 1008, one or more optional processes may be undertaken. For example, 1008 may include 1010, where the compound material is hardened. 1008 may also include 1012, where the plurality of alloyed particles is spheroidized.

1008 may also include other optional features, such as the plurality of ductile particles being aluminum particles, the plurality of brittle particles are at least silicon carbide, boron carbide, or titanium diboride, the plurality of alloyed particles are an additive manufacturing feedstock, and the milling comprising ball milling.

The previous description is provided to enable any person skilled in the art to practice the various aspects described herein. Various modifications to these exemplary embodiments presented throughout this disclosure will be readily apparent to those skilled in the art, and the concepts disclosed herein may be applied in other ways than the examples disclosed herein. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method comprising:
heating a metal into a liquid;
spraying the liquid through a nozzle to produce droplets;
directing a stream of ceramic particles to contact the droplets to form a compound material, the compound material comprising the droplets and the ceramic particles; and
obtaining a powder from the droplets.

2. The method of claim 1, further comprising directing a gas stream at the droplets to modify a surface tension of the droplets.

3. The method of claim 1, wherein obtaining the powder comprises spheroidizing the compound material into a powder.

4. The method of claim 1, wherein the metal is aluminum.

5. The method of claim 1, wherein the ceramic particles are at least silicon carbide, boron carbide, or titanium diboride.

6. The method of claim 1, wherein the powder is an additive manufacturing feedstock.

7. The method of claim 1, wherein the droplets are directed by a gas stream that comprises at least air, argon, or nitrogen.

8. The method of claim 1, wherein directing the stream of ceramic particles comprises directing the stream of ceramic particles via a gas stream.

9. A method comprising:
directing a stream of ceramic particles at a sheet of a metal to fix the ceramic particles to the sheet; and
atomizing the sheet into particles of a powder, wherein the particles include the ceramic particles and the metal.

10. The method of claim 9, further comprising rolling the sheet into a cylindrical object.

11. The method of claim 9, further comprising spheroidizing the particles of the powder.

12. The method of claim 9, further comprising maintaining a temperature of the sheet at or below a solidus temperature of the metal.

13. The method of claim 9, wherein the sheet is at least 0.10 mm thick.

14. The method of claim 10, wherein rolling the sheet comprises placing the sheet into a roller mill.

15. The method of claim 9, wherein atomizing the sheet comprises at least plasma atomization, ultrasonic atomization, wire arc atomization, or gas atomization.

16. The method of claim 9, wherein directing the stream of ceramic particles further comprises introducing the ceramic particles into a gas stream.

17. The method of claim 16, wherein the gas stream is at a pressure between 100 psi and 1000 psi.

18. The method of claim 16, wherein the gas stream comprises at least air, argon, or nitrogen.

19. The method of claim 9, wherein the powder is an additive manufacturing feedstock.

20. The method of claim 9, wherein the ceramic particles are between one nanometer and 10 microns in size.

21. A method comprising:
combining a plurality of ductile particles and a plurality of brittle particles;
cold welding the plurality of ductile particles and the plurality of brittle particles into a compound material by milling the plurality of ductile particles with the plurality of brittle particles; and
obtaining a plurality of alloyed particles from the compound material.

22. The method of claim 21, further comprising hardening the compound material.

23. The method of claim 21, further comprising spheroidizing the plurality of alloyed particles.

24. The method of claim 21, wherein the plurality of ductile particles are aluminum particles.

25. The method of claim 21, wherein the plurality of brittle particles are at least silicon carbide, boron carbide, or titanium diboride.

26. The method of claim 21, wherein the plurality of alloyed particles is an additive manufacturing feedstock.

27. The method of claim 21, wherein the milling comprises ball milling.
